(19) United States
(12) Patent Application Publication
(10) Pub. No.: US 2021/0038004 A1
(43) Pub. Date: Feb. 11, 2021

(54) Door for receiving and delivering orders

(71) Applicant: Daniel GRAÑA DOMÍNGUEZ, Vigo (Pontevedra) (ES)

(72) Inventor: Daniel GRAÑA DOMÍNGUEZ, Vigo (Pontevedra) (ES)

(21) Appl. No.: 16/976,744

(22) PCT Filed: Dec. 5, 2018
(86) PCT No.: PCT/ES2018/070787

§ 371 Date: Aug. 28, 2020

(30) Foreign Application Priority Data
Mar. 6, 2018 (ES) U201830295

(51) Int. Cl. A47G 29/14; E06B 7/32

(52) U.S. Cl. CPC A47G 29/141; E06B 2009/6818; A47G 2029/145; E06B 7/32

(57) ABSTRACT

The present invention relates to a door for receiving and delivering orders, characterized in that it comprises a hatch which can be arranged in an open position or in a closed position, and code entering means such that the hatch opens upon entering a predetermined code.

The present invention relates to a door for receiving and delivering orders, which can be used in a home and allows receiving and delivering orders without one having to be there.

### BACKGROUND OF THE INVENTION

E-commerce, whereby a buyer can shop online for virtually any product which can be delivered to the buyer's home within a short time period, is becoming increasingly more common.

One of the biggest problems in the world of online shopping today is the delivery of parcels when the recipient is not home.

This involves a significant expense for logistics companies in terms of times, second delivery attempt, fuel, staff, etc. and for the end user, who fails to receive the parcel within the established time, and who often has to go to the logistic facility to retrieve said parcel.

It is also detrimental to online shops as they undertake to deliver the parcel within the established time frame on their web pages.

The fact that, in everyday life, people do not spend their entire day at home due to work, leisure, and other daily chores means that parcel delivery is an arduous task for a delivery person, with the subsequent economic losses it entails.

The only solutions proposed today by logistics companies consist of delivering the parcel to a neighbor or to predetermined pick-up points which may be located a long distance from the home of the recipient. Therefore, these solutions are very far from being a definitive solution to this problem.

In the case of parcel delivery, parcel collection by the delivery person also poses a problem for the same reason of there being no one at home.

Therefore, an objective of the present invention is to provide a door which allows the recipient to be able to receive or send a parcel when he or she is not there.

### DESCRIPTION OF THE INVENTION

The mentioned drawbacks are solved with the door for receiving and delivering orders of the invention which has other advantages that will be described below.

The door for receiving and delivering orders according to the present invention comprises a hatch which can be arranged in an open position or in a closed position; and code entering means such that the hatch opens upon entering a predetermined code.

The delivery person can therefore deliver the order by simply knowing the predetermined code, without the recipient having to be at home.

Preferably, said code entering means comprise a code reader or a keypad for entering a code. The reader can be a reader of codes of any type, such as QR codes, barcodes, etc., or a touch screen to enable manually entering said code.

Advantageously, said hatch comprises an actuator for moving the hatch from the closed position to the open position and vice versa, and said actuator and said code entering means are connected to a processor, such that when the processor determines that the code which has been entered coincides with the predetermined code, it sends a signal for the actuator to open the hatch and another signal for closing the hatch after a predetermined time period.

Furthermore, the door for receiving and delivering orders according to the present invention may also comprise a drop-down tray arranged in the inner part of the door. This drop-down tray allows placing any object thereon, both for receiving the order and for delivering the order to an authorized delivery person who will open the hatch with the predetermined code to access the object.

The door for receiving and delivering orders according to the present invention may also comprise a volumetric sensor arranged in the inner part of the door for detecting the presence of an object on said drop-down tray.

To increase safety, said hatch may also comprise a lock connected to said processor, such that when the processor determines that the code which has been entered coincides with the predetermined code, it sends a signal for unlocking the lock to allow the opening of the hatch.

Furthermore, the door for receiving and delivering orders may also comprise an indicator indicating the position in which the hatch is arranged.

To protect the privacy of the door's user, the hatch may comprise a curtain which will not let the authorized delivery person see the inside of the home.

To prevent the door according to the present invention from becoming unavailable for use in the event of a power outage, said processor can be powered by means of a battery, which allows the opening and closing of the hatch in any case.

If desired, the door for receiving and delivering orders according to the present invention may also comprise an alarm which is activated in the event of an emergency.

According to a preferred embodiment, said hatch is articulated in the upper part thereof by means of hinges, although it may be opened and closed in any suitable manner to the right or left, according to the user's needs.

For example, said actuator for opening and closing the hatch is a pneumatic or hydraulic piston, although it may be any suitable actuator.

To facilitate installation, said processor is housed in a box which is connected to the actuator and to the code entering means by means of a connection plug.

### BRIEF DESCRIPTION OF THE DRAWINGS

To better understand what has been set forth, drawings in which a practical embodiment is schematically depicted only by way of non-limiting example are attached.

FIG. 1 is a front elevational view of the door for receiving and delivering orders according to the present invention in its closed position;

FIG. 2 is a rear elevational view of the door for receiving and delivering orders according to a first embodiment of the present invention in its closed position;

FIG. 3 is a rear elevational view of the door for receiving and delivering orders according to a second embodiment of the present invention in its closed position; and

FIG. 4 is a side elevational view of the door for receiving and delivering orders according to the second embodiment of the present invention in its open position.

### DESCRIPTION OF PREFERRED EMBODIMENTS

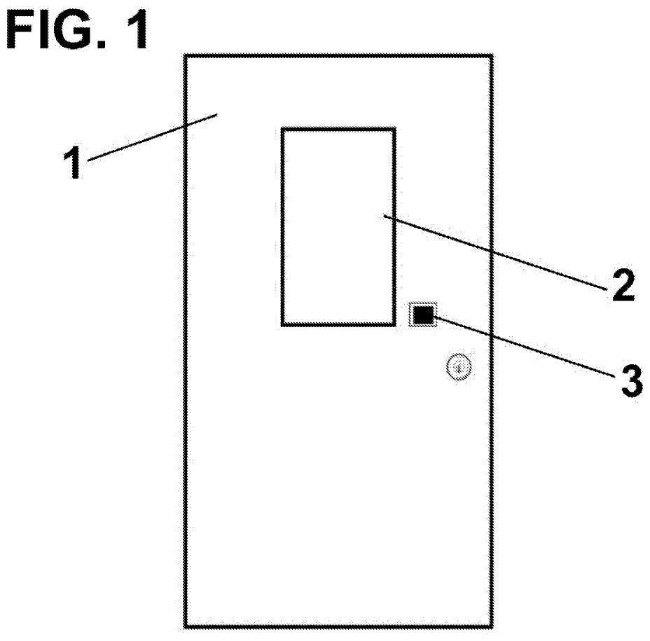

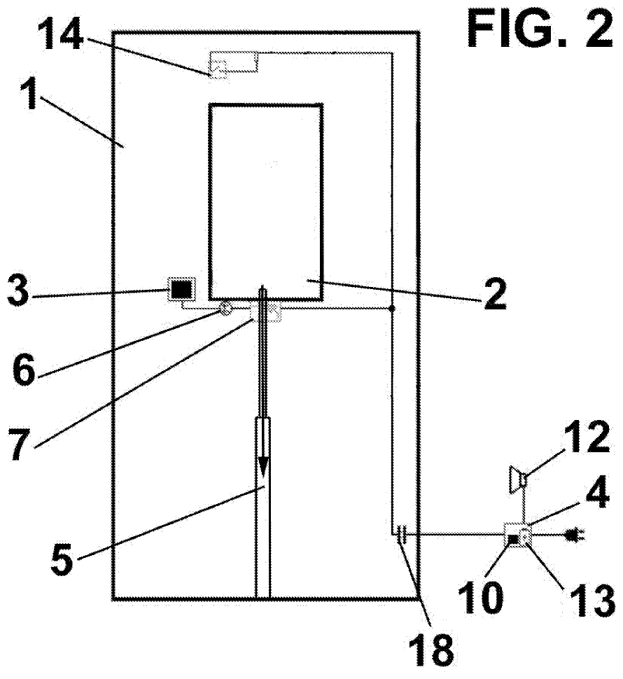

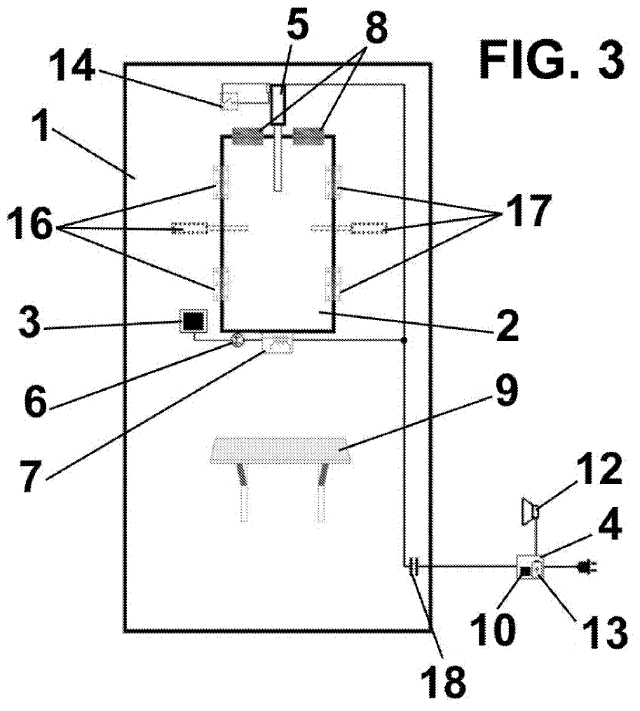

FIG. 1 shows the front part of the door for receiving and delivering orders according to the present invention, generally identified by means of reference number 1, and comprising a hatch 2 which can be arranged in a closed position (shown in FIGS. 1 and 2) or in an open position (shown in FIG. 3).

Furthermore, the door 1 also comprises code entering means 3, for example, a code reader, for example, a QR code reader, barcode reader, etc. or a keypad, for example, a virtual keypad on a touch screen, for manually entering a code.

FIG. 2 shows the rear part of the door for receiving and delivering orders according to a first embodiment of the present invention, in which it can be seen that said hatch 2 can be moved downwards (as indicated by means of the corresponding arrow) for being arranged in its open position, and the movement of which is driven by means of an actuator 5, for example, a piston.

According to the depicted embodiment, the door 1 also comprises a lock 7 which can be locked to prevent the opening of the hatch 2 and unlocked to allow the opening of the hatch 2.

The door 1 according to the present invention also comprises a processor 10 which is connected to the actuator 5 and to the code entering means 3, and also to the lock 7, if it is present, such that when one brings a delivery code close to the means 3 or enters it manually, the processor 10 verifies that it is correct and proceeds with the opening of the hatch 2.

Said processor 10 is powered by a battery 13 such that orders can be received and delivered even when there is no power supply, and it is housed in a box 4 which is connected to the actuator 5, to the means 3, and to the lock 7 by means of a plug 18 which allows readily connecting and disconnecting the electronic part to/from the mechanical part of the window 1 according to the present invention, for easy installation or replacement.

The processor 10 is also connected to an alarm 12 which sends a warning if necessary, as will be described below.

FIG. 3 shows a second embodiment of the door according to a present invention. According to this embodiment, said hatch 2 is articulated in the upper part thereof by means of hinges 8 and the movement of which is driven by means of an actuator 5, for example, a piston. However, it must be indicated that the hatch 2 may be articulated on the left or right side, as shown by means of dashed lines representing the corresponding hinges and actuators, identified with reference numbers 16 and 17.

The door 1 according to this embodiment of the present invention also comprises a drop-down tray 9 located in its inner part, which allows the placement of an object by the delivery person delivering an object, or by the user leaving an object on the tray 9 for the collection thereof by the delivery person.

The door 1 also comprises a volumetric sensor 6 which allows detecting the presence of an object placed on said drop-down tray 9, and an indicator 14 indicating the state of the hatch 2 (open or closed).

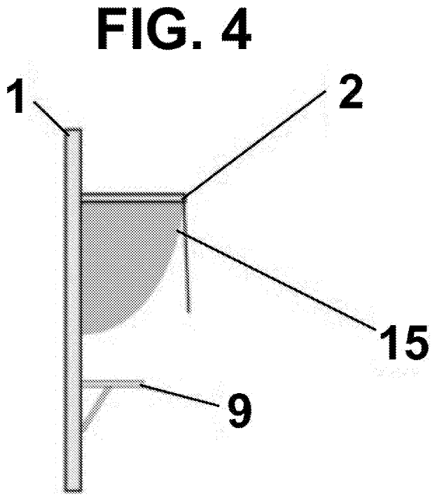

Furthermore, as shown in FIG. 4, the hatch 2 comprises a curtain 15 to assure the user's privacy, such that said curtain 15 prevents seeing the inside of the dwelling from outside when the hatch 2 is in its open position.

The operation of the door 1 according to the present invention is as follows. To receive an order delivered by a delivery person, the delivery person must enter a code through the means 3 located in the outer part of the door 1. The code can be entered manually or scanned by means of the reader of said means 3.

The code which has been entered is sent to the processor 10 which compares said code with a predetermined code or several predetermined codes, and if they coincide, the processor 10 sends a signal to the actuator 5 and to the lock 7, if it is present, for opening the hatch 2. Once the hatch 2 is open, the delivery person may leave the order in the dwelling of the user and then close the hatch 2.

The actuator 5 will not receive the closing order if movement is detected in the volumetric sensor 6, and the alarm 12 will go off if the time exceeds that programmed by the user.

Furthermore, the user will preferably be informed of every opening and closing of the hatch 2, as well as the reading and alarm codes, on his or her mobile telephone as a result of a permanent Internet connection.

Furthermore, if braking of the hatch 2 is caused on purpose, it will be stopped, and the alarm 12 will be triggered, and a message will be sent to the user's mobile. When the locking is released, the sole purpose of the hatch 2 is to close, and it will attempt to do so repeatedly until it closes up.

In the event that the user wants to return an order to the delivery person, the user will simply have to place the order on the drop-down tray 9 located inside the door 1.

For the delivery person to collect the order, he or she must enter a predetermined code as described above, allowing the opening of the hatch 2 and accessing the order placed on the tray 9.

The closing of the hatch 2 will be carried out in the same manner described above, also informing the user of same and activating the alarm 12, if necessary.

Although reference has been made to a specific embodiment of the invention, it is obvious for one skilled in the art that the door for receiving and delivering orders described is susceptible to a number of variations and modifications, and that all the mentioned details can be replaced with other technically equivalent details without departing from the scope of protection defined by the attached claims.

1. Door (1) for the reception and delivery of orders, characterized by comprising:
a hatch (2) that can be placed in an open position or in a closed position;
Y means for entering a code (3), so that the flap (2) is opened by entering a predetermined code.

2. Door (1) for receiving and delivering orders according to claim 1, wherein said means for entering a code (3) comprise a code reader or a keypad for entering a code.

3. Door (1) for receiving and delivering orders according to claim 1, wherein said trap door (2) comprises an actuator (5) to move it from the closed position to the open position and vice versa.

4. Door (1) for receiving and delivering orders according to claim 3, wherein said actuator (5) and said means for entering a code (3) are connected to a processor (10), so that when the processor (10) determines that the code entered matches the default code, it sends a signal for the actuator (5) to open the trapdoor (2) and another signal to close the trapdoor (2) after a period of default time.

5. Door (1) for receiving and delivering orders according to claim 1, which also comprises a folding tray (9) placed inside the door (1).

6. Door (1) for receiving and delivering orders according to claim 5, which also comprises a volumetric sensor (6) placed inside the door (1) to detect the presence of an object in said tray folding (9).

7. Door (1) for receiving and delivering orders according to claim 4, wherein said hatch (2) comprises a lock (7) connected to said processor (10), so that when the processor (10) determines that the code entered matches the default code, it sends a signal so that the lock (7) is unlocked to allow the trapdoor (2) to open.

8. Door (1) for receiving and delivering orders according to claim 1, comprising an indicator (14), indicating the position in which the trapdoor (2) is placed.

9. Door (1) for receiving and delivering orders according to claim 1, wherein the hatch (2) comprises a curtain (15).

10. Door (1) for receiving and delivering orders according to claim 4, wherein said processor (10) is powered by a battery (13).

11. Door (1) for receiving and delivering orders according to claim 1, comprising an alarm (12) that is activated in case of emergency.

12. Door (1) for receiving and delivering orders according to claim 1, wherein said trapdoor (2) is articulated at its top by hinges (8).

13. Door (1) for receiving and delivering orders according to claim 4, wherein said actuator (5) is a pneumatic or hydraulic piston.

14. Door (1) for receiving and delivering orders according to claim 4, wherein said processor (10) is housed in a box (4) that is connected to the actuator (5) and to the means for introducing a code (3) by means of a plug (18).
